(19) United States
(12) Patent Application Publication
(10) Pub. No.: US 2017/0114783 A1
(43) Pub. Date: Apr. 27, 2017

(54) METHOD AND DEVICE FOR ACTUATING A RECIPROCATING PUMP

(71) Applicant: Robert Bosch GmbH, Stuttgart (DE)

(72) Inventors: Michael Fischer, Niefern-Oeschelbronn (DE); Sebastian Wedman, Swarzedz (PL); Thorsten Allgeier, Untergruppenbach (DE); Walter Maeurer, Korntal-Muenchingen (DE)

(21) Appl. No.: 15/316,975

(22) PCT Filed: Jun. 3, 2015
(86) PCT No.: PCT/EP2015/062322

§ 371 Date: Dec. 7, 2016

(30) Foreign Application Priority Data
Jun. 20, 2014 (DE) 10 2014 211 895.6

(51) Int. Cl. F04B 49/06; G05B 15/02; F02M 59/02; F04B 53/00; F04B 17/04

(52) U.S. Cl. CPC F04B 49/065; F04B 53/001; F04B 17/04; F02M 59/02; G05B 15/02

(57) ABSTRACT

A method and a device for actuating a piston pump, the piston pump being actuated with a clock-pulse rate, the off-times being varied stochastically.

### BACKGROUND INFORMATION

The present invention relates to a device and a method for actuating a reciprocating pump. Reciprocating pumps are usually actuated by an electrical control signal with a specific clock-pulse rate and/or a specific pulse duty factor. The clock-pulse rate and/or the pulse duty factor may be specified in a fixed manner or specified as a function of the operating point. For example, such reciprocating pumps are used to deliver fuel into internal combustion engines. In this case, the actuation is preferably a function of the operating point of the internal combustion engine.

### SUMMARY

Such methods for actuating a reciprocating pump with a fixed pulse duty factor or with a fixed clock-pulse rate have the disadvantage that the pump emits a noise which is in definite proportion to the control frequency of the reciprocating pump.

On the other hand, the example method of the present invention and the example device of the present invention may have the advantage that the noise emissions are markedly reduced. In particular, this may be achieved by stochastically varying the off-times of the actuation.

This means that the off-time is changed from actuation to actuation.

It is especially advantageous if the clock-pulse rate (TR) is calculated based on a pump delivery rate. In this manner, the pump delivery rate may be varied by the selection of the clock-pulse rate, and adjusted to the need.

In particular, it is advantageous if the variation value (V) is limited in its absolute value. This ensures that the off-time does not drop below a minimum value, below which, the functioning of the reciprocating pump is no longer guaranteed.

It is particularly advantageous if the mean value of the variation values (V) assumes the value zero. In this way, the average clock-pulse rate remains constant, or changes as required.

In a further aspect, the present invention relates to program code together with processing instructions for creating a computer program executable on a control unit, especially source code with compiling and/or linking instructions, the program code yielding the computer program for implementing all steps of one of the methods described when it is converted into an executable computer program according to the processing instructions, thus, especially is compiled and/or linked. In particular, this program code may be provided by source code which, for instance, is able to be downloaded from a server on the internet.

### BRIEF DESCRIPTION OF THE DRAWINGS

Exemplary embodiments of the present invention are represented in the figures and explained in the description below.

FIG. 1 shows the schematic representation of a reciprocating pump.

FIG. 2 shows a flow chart of the procedure according to the present invention.

### DETAILED DESCRIPTION OF EXAMPLE EMBODIMENTS

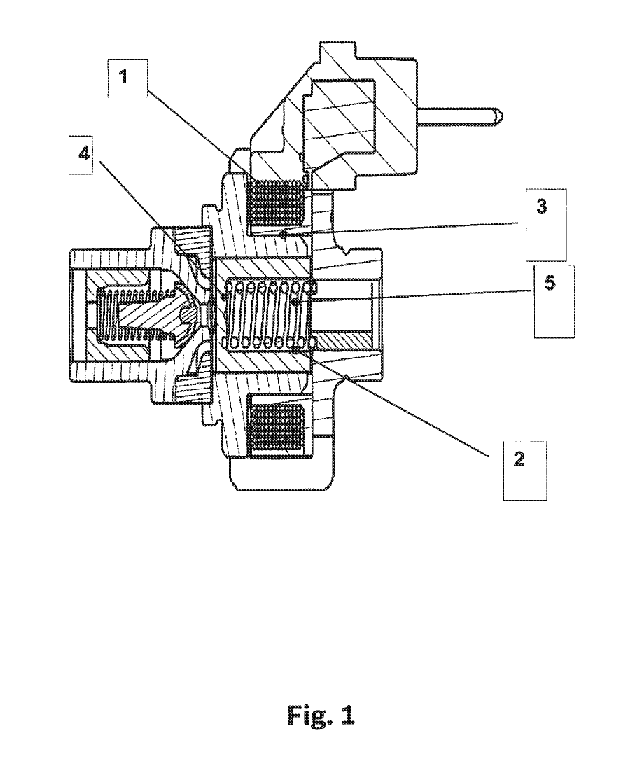

FIG. 1 illustrates a reciprocating pump. Such an electromagnetically operated reciprocating pump functions as follows.

A solenoid coil 1 is energized and attracts a piston/magnet armature 2. The piston or magnet armature 2 travels in a cylinder 3. During this process, fuel is sucked into compression chamber 4. When the magnetic field is switched off, a spring 5 pushes piston/magnet armature 2 forward and compresses the fuel and expels it again.

In another type of pump, the principle may also be reversed, that is, upon switch-off of the solenoid valve, the fuel is sucked in, and upon switching-on, is expelled in compressing fashion.

Owing to the piston principle, the piston moves to and fro and generates an operating noise which is characterized by the operating frequency as well as the natural frequency and harmonic waves of the mechanical components, especially upon occurrence at the mechanical stops. Conventionally, these noise emissions are minimized by mechanical and/or hydraulic damping mechanisms. This procedure does not always deliver sufficiently satisfactory results or, generally, is linked to higher costs in the case of the pump.

The procedure according to the present invention provides the possibility of effectively reducing the subjectively perceived operating noises of such reciprocating pumps. Especially in practical applications where other operating noises are present, e.g., in the case of the use of a fuel pump in combustion engines, the characteristic of the pump operating noise may be altered favorably by the actuation strategy described. In the process, the pump noise is masked, that is, is pushed into the background, and is no longer perceived as irritating.

According to the present invention, the electrical actuation for the respective operating point for an average delivery rate or frequency of the pump does not take place with a steady clock-pulse rate, but rather with an irregular sequence of drive pulses, in which the off-times are varied in the pulse duty factor. After each pump stroke, the off-time up to the next energizing is altered. The assignment of the new off-time takes place in a stochastic sequence, with the exceptional feature that the average clock-pulse rate, and therefore the average pump delivery rate remain constant for the respective operating point.

As a result of this actuation strategy, the noise characteristic of the pump changes. The dominant tonal component of the noise changes in the direction of a murmur. The individual spectral lines lose in amplitude, and a broad noise spectrum develops with low amplitudes. The overall sound power is not necessarily reduced by this method. Subjectively, however, the noise becomes markedly less conspicuous, especially if a similar background noise is already present in the practical application, e.g., during the operating of a combustion engine.

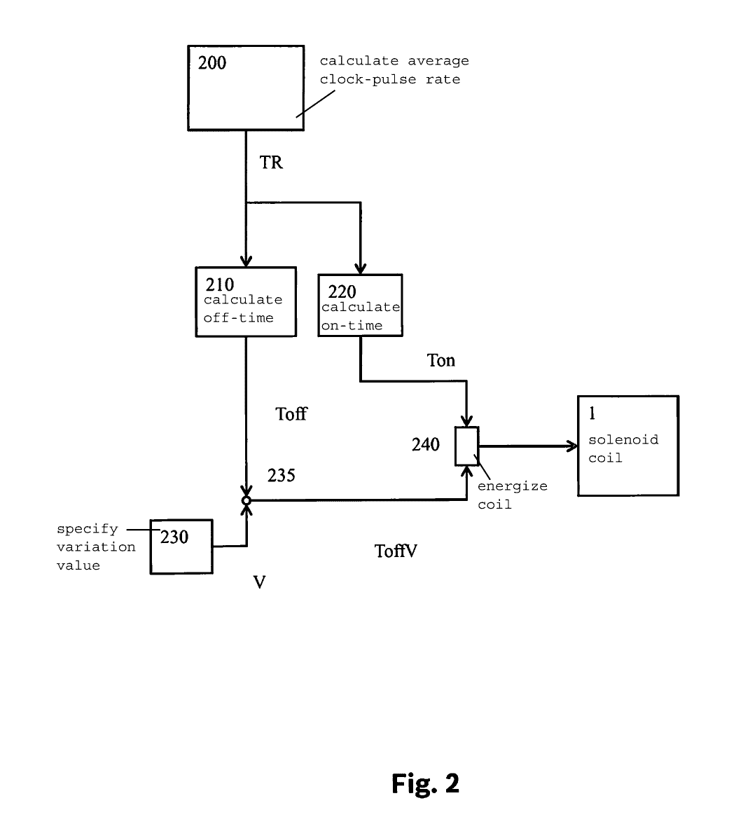

FIG. 2 shows a form of the procedure according to the present invention. This specific embodiment relates to a method for actuating a fuel pump in an internal combustion engine. However, the procedure of the present invention is not limited to this practical application. It may also be used in other applications of corresponding control sleeve fuel-injection pumps.

In a first step 200, an average clock-pulse rate TR is calculated. This average clock-pulse rate TR is calculated based on the operating state of the internal combustion engine. In this context, a fuel quantity to be delivered is calculated based on the operating state of the internal combustion engine. The clock-pulse rate is then computed based on this fuel quantity to be delivered.

Based on clock-pulse rate TR, an off-time Toff is calculated in a block 210, and an on-time Ton is calculated in block 220. On-time Ton is the period of time for which the solenoid coil is energized per actuation. Off-time Toff is the period of time in which the solenoid coil is not energized per actuation. The clock-pulse rate corresponds to the rate of actuation in a certain space of time, and is therefore a measure for the frequency of the actuation. Clock-pulse rate TR determines the total time of the actuation, and therefore the sum of on-time Ton and off-time Toff.

At a high clock-pulse rate, that is, given frequent actuation, a great deal of fuel is delivered. At a low clock-pulse rate, that is, in the case of infrequent actuation, little fuel is delivered.

In order to match the fuel delivery to the needs of the internal combustion engine, it is especially advantageous if, in block 200, clock-pulse rate TR is ascertained as a function of the operating state of the internal combustion engine. To that end, preferably clock-pulse rate TR is read out from a characteristic map.

A block 230 specifies a variation value V, with which off-time Toff is varied in summing junction 235. Off-time Toff between two drive pulses is thereby varied stochastically for each actuation cycle. In so doing, the variation may be implemented in discrete steps or continuously. In this context, for realization on a control unit, discrete step numbers in power-of-two steps are advantageous (2, 4, 8, 16, . . . ). The variation of the off-time in the resolution indicated above takes place within a reasonable maximum adjustment interval. A maximum deviation of approximately +/−20% relative to the average period duration has proven to be advantageous for this, depending on the field of application and the acoustic properties of the application. The step sizes must be ascertained in such a way that the mean value of the off-time variations is zero, since otherwise the average delivery quantity changes. For implementation in a control unit, the implementation with discrete steps is advantageous. The maximum adjustment interval is then divided by the number of discrete steps ascertained and assigned to a binary numeric code. A switchover is now carried out between the codes, thus, the quantified step sizes, after each pump cycle using a random sequence generated in digital or analog fashion.

Off-time ToffV varied in this manner reaches output stage 240, which energizes solenoid coil 1 accordingly.

For example, the stochastic binary sequence may be obtained from a pseudo-random sequence that may be generated easily in electronic manner using feedback shift registers, or in terms of software, on a computer or microcontroller. Pseudo-random sequence means that the distribution is indeed stochastic, but repeats after a certain length of the sequence. The longer the sequence, the higher the quality of the random sequence. The generation of random sequences is conventional.

Due to such a specification of the variation value, the mean value of the variation values assumes the value zero. If the variation values are specified by a different procedure, this specification is then implemented in such a way that the mean value of the variation values assumes the value zero.

1-10. (canceled)

11. A method for actuating a piston pump, comprising:
actuating the piston pump with a specific clock-pulse rate and a specific off-time; and
varying off-times of the piston pump stochastically.

12. The method as recited in claim 11, wherein the clock-pulse rate is calculated based on a pump-delivery rate.

13. The method as recited in claim 11, wherein the off-times are altered from actuation to actuation by a variation value.

14. The method as recited in claim 13, wherein the variation value assumes discrete values.

15. The method as recited in claim 13, wherein the variation value is limited in its absolute value.

16. The method as recited in claim 13, wherein a mean value of the variation values assumes a value zero.

17. A non-transitory machine readable storage medium on which is stored a computer program for actuating a piston pump, the computer program, when executed by a control unit, causing the control unit to perform:
actuating the piston pump with a specific clock-pulse rate and a specific off-time; and
varying off-times of the piston pump stochastically.

18. A control unit designed to actuate a piston pump, the control unit designed to:
actuate the piston pump with a specific clock-pulse rate and a specific off-time; and
vary off-times of the piston pump stochastically.

19. A non-transitory computer-readable storage medium storing program code together with processing instructions for creating a computer program executable on a control unit, the program code yielding the computer program when it is converted according to the processing instructions into an executable computer program, the computer program for actuating a piston pump, including actuating the piston pump with a specific clock-pulse rate and a specific off-time and varying off-times of the piston pump stochastically.
